(19) United States
(12) Patent Application Publication
(10) Pub. No.: US 2006/0081248 A1
(43) Pub. Date: Apr. 20, 2006

(54) Patient oxygen delivery mask

(75) Inventor: Lee McDonald, Barrie (CA)

Correspondence Address: NIKOLAI & MERSEREAU, P.A., 900 SECOND AVENUE SOUTH, SUITE 820, MINNEAPOLIS, MN, 55402, US

(73) Assignee: SOUTHMEDIC INCORPORATED, Barrie (CA)

(21) Appl. No.: 10/966,920

(22) Filed: Oct. 15, 2004

(51) Int. Cl. A62B 18/02; A62B 23/02

(52) U.S. Cl. 128/205.25; 128/206.21; 128/206.15

(57) ABSTRACT

A mask for delivery of oxygen to a patient, comprising a body having a peripheral portion to sit comfortably on a patient's face, a central portion, and bridge portions extending between the central portion and the peripheral portion and integral therewith, the central portion having an inner surface and an outer surface, the inner surface oriented towards the patient's face and spaced over the patient's nose and mouth, the inner surface of the central portion including a wall circumscribing a base, the wall and base being of generally concave configuration and circumscribing a centrally positioned oxygen delivery aperture extending through the central portion, the wall and base configured so as to act as an oxygen diffuser to direct the flow of oxygen generally towards the patient's nose and mouth when the mask is in use.

### FIELD OF THE INVENTION

The present invention relates to a novel mask for delivery of oxygen to a patient, and more particularly to a mask which can be used to replace conventional oxygen masks and nasal cannulae oxygen delivery systems.

### BACKGROUND OF THE INVENTION

Conventional oxygen masks comprise tent like structures which are strapped over the nose and mouth of the patient, often using an elastic band or bands behind the patient's ears or head. Oxygen is fed from a supply through a tube into the bottom portion of the mask at the front of the patient. Many problems exist with such masks, including the fact that many patients find them claustrophobic, the mask must be removed for the patient to speak or eat, thereby discontinuing therapy, and the face mask creates irregular and inefficient infusion of oxygen by the patient since exhaled air from the patient is mixed with oxygen in the mask. Oxygen masks can only be used for oxygen flows greater than 4 litres/minute because exhaled gas accumulates in the mask, and, at lower flow rates interferes with delivery of oxygen-enriched air to the patient.

Conventional nasal cannulae oxygen delivery systems employ an oxygen delivery tube with tubular, open ended nasal prongs at the delivery end of the tube for insertion into a patient's nasal passages. The oxygen delivery tube and nasal cannulae are supported in position by a tube wrapped about the patient's ears or head, making the system both difficult to handle and uncomfortable since it applies downward pressure on the patient's ears when the patient is in a seated position. As well, patients often get nose bleeds from the dryness of the oxygen supplied through the nasal cannulae. Patients also get sores on the ears, face and nose due to the direct contact of the oxygen tubing with the skin. Nasal cannulae can only deliver flows of 0.5 to 4 litres/minute.

Of background interest is Ketchedjian, U.S. Pat. No. 6,247,470 issued Jun. 19, 2001 which describes and illustrates an oxygen delivery apparatus comprising a headset to which is pivotally attached, for rotation in one plane, a flexible arm carrying tubular members for passing oxygen to a patient's mouth. The apparatus is also provided with a carbon dioxide monitoring system.

McCombs et al., U.S. Pat. No. 6,065,473 issued May 23, 2000 describes a somewhat similar apparatus, for non-medical purposes, intended to dispense concentrated oxygen to users, the apparatus comprising an oxygen delivery nozzle attached by an arm extending from a flexible head band, to bathe the user's nose and mouth with oxygen, when in use. Laid-open German Application DE 43 07 754 A1, published Apr. 7, 1994, teaches a system for controlled supply or removal of respiratory air from a user, which system incorporates a mask body held by a rigid air tube over the mouth and/or nose of the user, the air tube being pivotally adjustable in one plane, to enable proper positioning of the mask.

U.S. Pat. No. 3,683,907 of Cotabish issued Aug. 15, 1972 describes and illustrates a fresh air respirator, for use for example by miners, which comprises a cup, supported by pivotable arms in front of the face of the user, a stream of air being conducted to the cup to provide fresh air around the user's nose and mouth.

The applicant has developed a number of lightweight oxygen delivery systems for patients, as described for example in U.S. Pat. Nos. 6,675,796 issued Jan. 13, 2004, 6,595,207 issued Jul. 22, 2003 and 6,450,166 issued Sep. 17, 2002. Also, applicant's U.S. Design Pat. Nos. D449,376 issued Aug. 16, 2003 and D449,883 issued Oct. 30, 2001 illustrate designs for such devices. All of these references feature oxygen diffuser devices, designed to create a turbulent oxygen flow, to be situated during use in front of the nose and mouth of a patient, and being held in that area by means of a mount such as a head band, to which is secured a rigid, but bendable oxygen delivery tube. The subject matter of each of these references is incorporated herein by reference.

Other references of general background interest include U.S. Pat. No. 4,282,869 of Zidulka issued Aug. 11, 1981, U.S. Pat. No. 4,018,221 of Rennie issued Apr. 19, 1977, U.S. Pat. No. 5,687,715 of Landis et al. issued Nov. 18, 1997, U.S. Pat. No. 4,465,067 of Koch et al. issued Aug. 4, 1984 and U.S. Pat. No. 5,697,363 of Hart issued Dec. 16, 1977, all of which describe and illustrate different types of head mounted apparatus for delivering oxygen or other gases to a patient.

Most of these prior art devices intended for delivery of oxygen to a patient do not provide the ease of usage, both by health care workers and the patient, and reliability against unintended removal or dislodgement from position, as is required to permit widespread use by the health care profession.

It is an object of the present invention to provide a more versatile, reliable and practical system for delivery of oxygen to patients.

### SUMMARY OF INVENTION

In accordance with the present invention there is provided an improved mask for delivery of oxygen to a patient. The mask comprises a body having a peripheral portion, when in use to sit comfortably on a patient's face, a central portion, and bridge portions extending between the central portion and the peripheral portion and integral therewith. The central portion has an inner surface and an outer surface. The inner surface is oriented towards the patient's face, when the mask is in position, and is contoured so as to sit at a location spaced over the patient's nose and mouth. The inner surface of the central portion is provided with a wall circumscribing a base. The wall and base are of generally concave configuration and circumscribe a centrally positioned oxygen delivery aperture which extends through the central portion between the inner surface and the outer surface. The wall and base are configured so as to act as an oxygen diffuser to direct the flow of oxygen generally towards the patient's nose and mouth when the mask is in use. Means are provided on opposite sides of the peripheral portion, for securing a flexible strap means to extend behind the patient's head to hold the mask in position when in use. Also, means are associated with the aperture and of the central portion releasably to secure in position an oxygen delivery tube.

In a further embodiment of the present invention, the mask additionally includes the oxygen delivery tube. It is releasably securable to the outer surface of the central portion of the mask so as to communicate with the oxygen delivery aperture. As well, a baffle is provided, the baffle being constructed so as to be releasably seated over the oxygen delivery aperture on the inner surface of the central portion of the mask. The inner surface of the baffle is configured so as to assist, during use of the mask, in creating turbulence in an oxygen flow leaving the oxygen delivery aperture and assist in mixing oxygen with ambient air and thereby avoid a direct flow of oxygen towards the patient's face.

In a yet a further embodiment of the present invention, the mask is further provided with an oxygen/carbon dioxide monitor tube releasably securable to the outer surface of the central portion of the mask, so as to communicate through the oxygen delivery aperture with an area above the inner surface of the central portion during use of the mask for passage of air within the mask to an oxygen/dioxide monitor. The baffle is constructed so as to be releasably seated over the oxygen delivery aperture on the inner surface of the central portion of the mask. The baffle has a concave shaped wall and is configured and positioned so as to assist during use of the mask in creating turbulence in an oxygen flow leaving the oxygen delivery aperture and assist in mixing oxygen with ambient air and thereby avoid a direct flow of oxygen toward a patient's face. A carbon dioxide intake is positioned within the concave shaped wall of the baffle, the carbon dioxide intake communicating with the carbon dioxide monitor tube.

It is preferred that the bridge portions of the mask, from a top of the mask to a bottom of the mask, are configured in an inverted “Y” shape so that openings are provided towards the bottom and on both sides of the mask for unobstructed access to, and viewing of a patient's mouth and others parts of the patient's face.

The oxygen delivery mask of the present invention provides an extremely easy to use, comfortable, reliable and efficient mask for delivery of oxygen to a patient. As well, since this mask construction does not provide complete enclosure over the patient's nose and mouth, zthere is no chance of claustrophobia.

### BRIEF DESCRIPTION OF THE DRAWINGS

These and other advantages of the invention will become apparent upon reading the following detailed description and upon referring to the drawings in which:

FIG. 1 is an exploded perspective view from the rear of one embodiment of the oxygen delivery mask according to the present invention;

FIG. 2 is an elevational section view of the mask of FIG. 1, along lines 2-2 of FIG. 1;

FIG. 3 is a perspective view from the front of the mask of FIG. 1;

FIG. 4 is an elevational section view of an alternative embodiment of oxygen delivery mask in accordance with the present invention, including a carbon dioxide monitoring function; and

FIG. 5 is a front elevation view of the mask of FIG. 1.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENTS

In the following description similar features in the drawings have been given similar reference numerals.

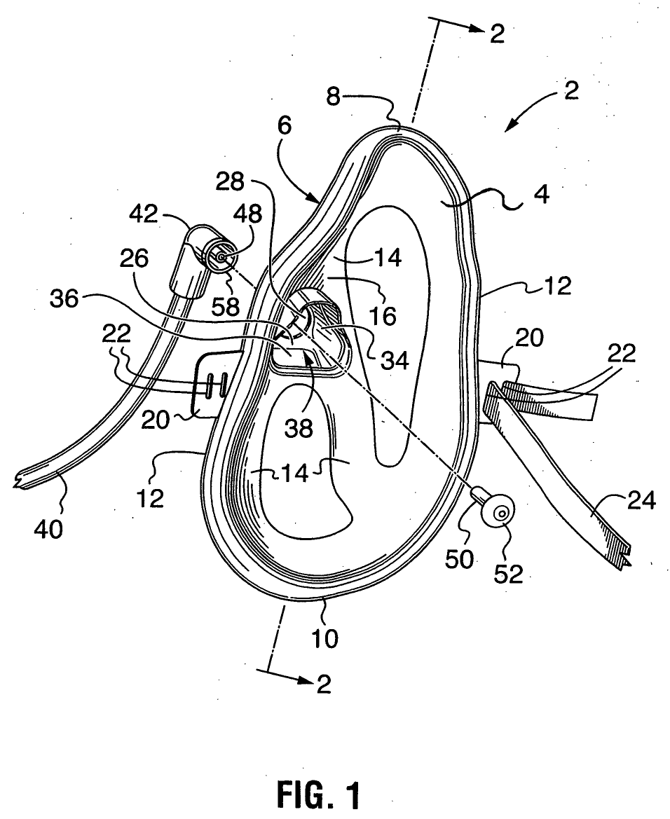

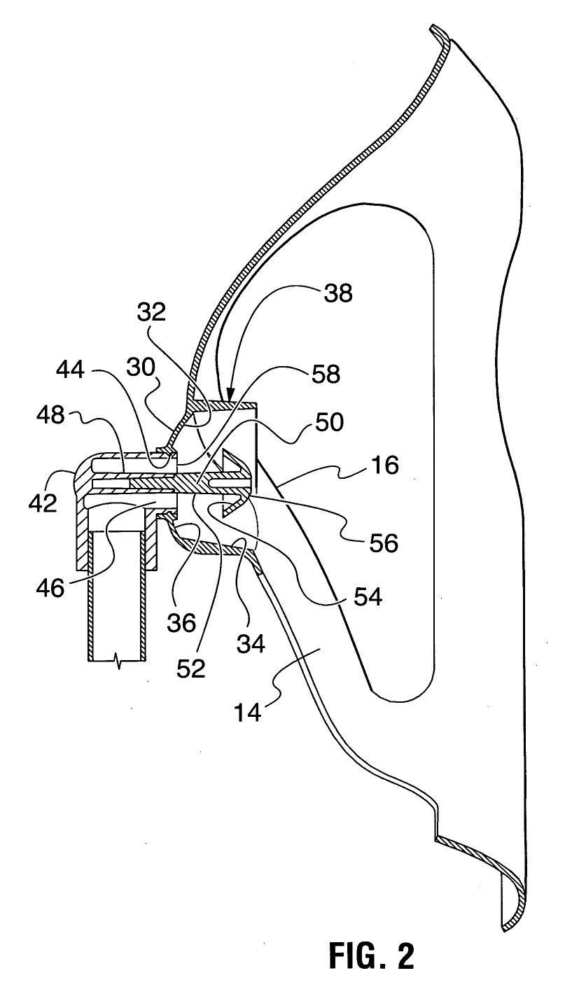

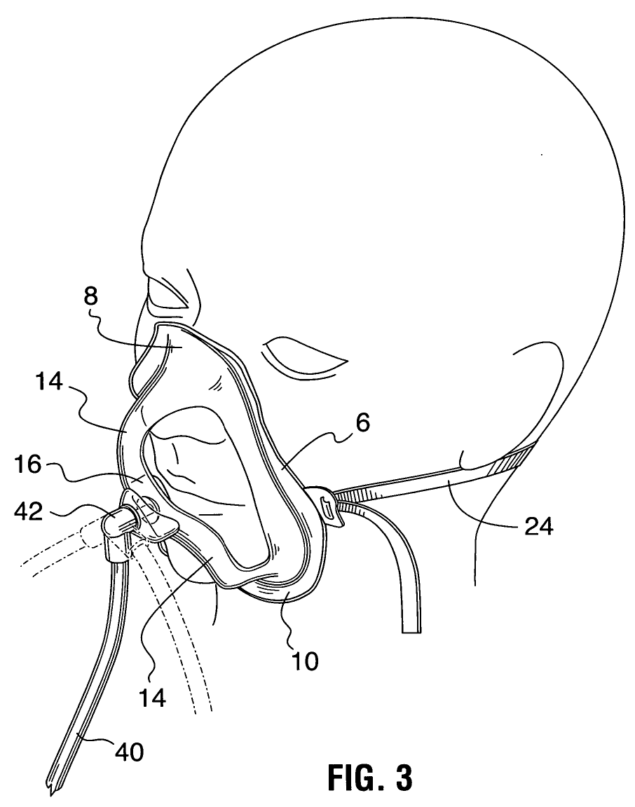

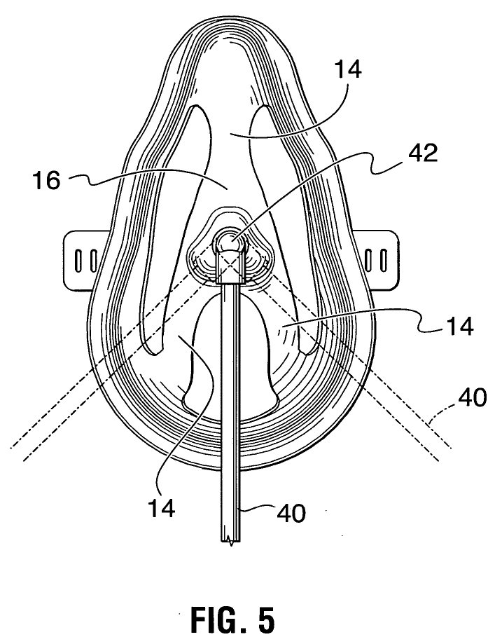

Turning to FIGS. 1 and 2 there is illustrated an oxygen delivery mask 2 in accordance with the present invention. Mask 2 is made up of a body 4 having a peripheral portion 6 with a top 8 and a bottom 10. Sides 12 extend between top 8 and bottom 10. As can be seen in FIG. 3, peripheral portion 6, when mask 2 is in use, rests on portions of a user's face both above the user's nose (top 8) and on the user's chin (bottom 10). Integrally formed with peripheral portion 6 are bridge portions 14 which integrally connect with a central portion 16. Bridge portions 14 and central portion 16 have an inverted “Y” shaped configuration (from top to bottom of the mask), when viewed from the front (FIG. 5), providing unobstructed access to and viewing of the patient's mouth and other parts of the patient's face, so that for example, the patient may eat and drink without removing the mask. Of course other configurations of bridge portions may be provided as desired or appropriate, such as, for example, an “X” shape, a “+” shape or “T” shape. Peripheral portion 6, bridge portions 14 and central portion 16 are preferably made of a fairly soft, semi rigid plastic material. Tabs 20 extend outwardly from sides 12, and are provided with, for example, slots 22 in which may be adjustably secured ends of an elastic strap 24 for releasably securing the mask 2 in position on a user's face (FIG. 3). As will be understood from FIGS. 1 and 3, peripheral portion 6, bridge portions 14 and central portion 16 are contoured so as to rise from base 26 of peripheral portion 16 in a curved contour so that central portion 16 sits spaced over the nose and mouth of the patient when the mask 2 is in position. A circular aperture 28 extends through central portion 16 from outer surface 30 to inner surface 32.

Integrally formed on inner surface 32 of central portion 16, is a triangular wall 34, extending about a base 36 which circumscribes circular aperture 28. This wall 34 and base 36 are of generally concave configuration, with one of the apexes of the triangle formed by wall 34 being oriented towards top 8 of mask 2 and the other two apexes oriented towards bottom 10. This wall and base form a diffuser 38 which has a similar function to the diffuser construction described and illustrated in applicant's earlier patents and applications referred to previously herein.

In the embodiment of mask illustrated in FIGS. 1 to 3, an oxygen delivery tube 40 is secured in a rigid elbow 42, elbow 42 being rotatably secured by an appropriate, conventional securing means such as frictional engagement in aperture 28 or its snapping into an undercut 44 about aperture 28 on the outer surface 30, so that it can pivot about the circumference of aperture 28 (FIGS. 3 and 5). Elbow 42 provides a passageway 46 for delivery of oxygen, during operation of the device, into diffuser 38 on the inner surface 32 of central portion 16. An upstanding stem 48 within elbow 42 provides a means for releasable attachment thereto of post 50 of mushroom shaped baffle 52. As can be seen in FIG. 2, the inner end of baffle 52 has a curled back conical lip 54 on its head 56, the underside of this lip being in line with oxygen passing from aperture 26 at the inner end 58 of elbow 42. This curled back conical lip 54 is of a size and configuration, with respect to wall 34 of diffuser 38, such that turbulence is generated in the stream of oxygen passing from elbow inner end 58 and aperture 28, creating a plume of oxygen enriched air at the patient's nose and mouth when the mask is in position.

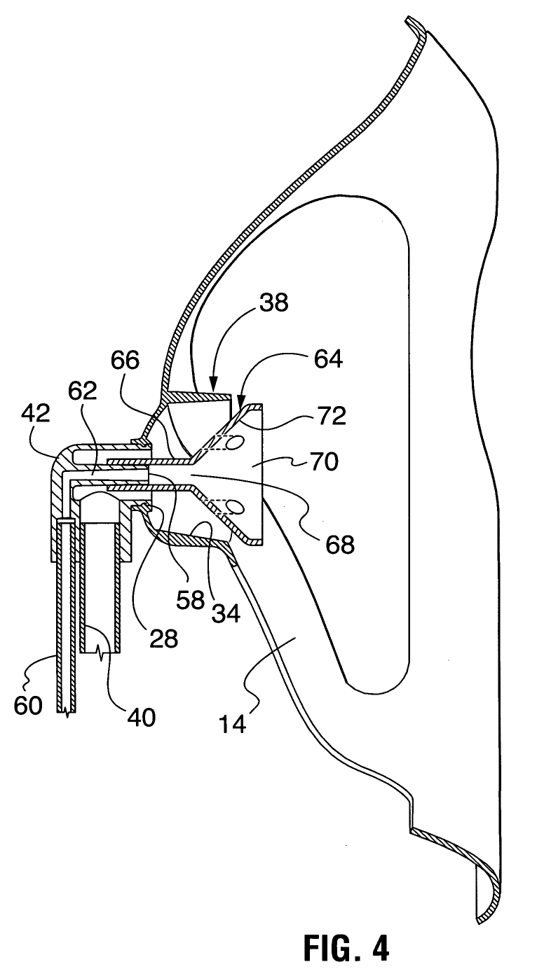

In the alternative embodiment of mask 2 illustrated in FIG. 4, while mask body 4 and integral diffuser 38 are of a similar configuration to those of FIGS. 1, 2 and 3, in addition to an oxygen delivery tube 40 passing into elbow 42, elbow 42 is configured to have an oxygen/carbon dioxide monitor tube 60 secured to it, which tube communicates with a separate oxygen/carbon dioxide monitor passageway 62 extending within elbow 42 to its inner end 58. Oxygen/carbon dioxide monitor tube 60 and passageway 62 are separate and independent from oxygen delivery tube 40 and oxygen delivery passageway 46. Oxygen from delivery tube 40 is again delivered through elbow 42 to aperture 28 and the inside of mask 2 and the wall 34 of diffuser 38 circumscribes this aperture 28 and directs the flow of oxygen generally outwardly from diffuser 38.

In this embodiment, baffle 64 has a hollow post 66 the hollow center communicating with an opening 68 on the inside of baffle 64, and with the oxygen/carbon dioxide monitor passageway 62 and tube 60.

Head 70 of the baffle 64 circumscribes the opening 68, the head being of a concave shape formed by wall 72. This head 70 fills a significant part of the interior of diffuser 38. Wall 72 extends outwardly beyond the edges of wall 34, and generates the necessary oxygen turbulence to provide an effective plume of oxygen for delivery to the nose and mouth area of the patient when the mask 2 is in position. At the same time however, an effective oxygen/carbon dioxide monitoring of the patient's exhaled breath is permitted through the oxygen/carbon dioxide monitor opening 68 within head 70.

In tests which have been done and proven the efficacity of the mask design according to the present invention, it has been determined that patients find the mask according to the present invention to be far more comfortable than conventional oxygen masks. Unlike conventional masks, users cannot feel oxygen being delivered to their nose and mouth area, and enjoy the compactness of the mask. Technically, lower flow rates of oxygen to a patient through the mask of the present invention can be achieved, with as much or greater oxygen concentration in the air being delivered to the patient, as compared to conventional oxygen masks. In this manner, the mask according to the present invention provides both comfort and efficiency to patients which providing optimal blood oxygen saturation in a cost effective manner. Flow rates ranging from 0.5 litres to 15 litres per minute have proven suitable providing a far greater range of possible flow rates than available through conventional oxygen delivery devices.

As well, the mask design of the present invention allows a patient to drink, eat, be suctioned and speak, without removal of the mask. Also, exhaled air does not collect in the area in front of the patient's nose and mouth and interfere with the mask's operation, as in the case of conventional oxygen masks, since exhaled air easily passes to the surrounding environment through the spaces between the bridge portions and the peripheral portion of the mask.

Thus, there has been provided in accordance with the invention a patient oxygen delivery system that fully satisfies the objects, aims and advantages set forth above. While the invention has been described in conjunction with illustrated embodiments thereof, it is evident that many alternatives, modifications and variations will be apparent to those skilled in the art in light of the foregoing description. Accordingly, it is intended to embrace all such alternatives, modifications and variations as fall within the spirit and broad scope of the invention.

1. (canceled)

2. A mask according to claim 12 in combination with an oxygen delivery tube releasably securable to the outer surface of the central portion of the mask so as to communicate with the oxygen delivery aperture.

3. A mask according to claim 2 further provided with a baffle, the baffle being constructed so as to be releasably seated over the oxygen delivery aperture on the inner surface of the central portion of the mask, the inner surface of the baffle being configured so as to assist during use of the mask in creating turbulence in an oxygen flow leaving the oxygen delivery aperture and assist in mixing oxygen with ambient air and thereby avoid a direct flow of oxygen towards the patient's face.

4. A mask according to claim 2 further provided with an oxygen/carbon dioxide monitor tube releasably securable to the outer surface of the central portion of the mask, so as to communicate through the oxygen delivery aperture with an area above the inner surface of the central portion, during use of the mask, for passage of air within the mask to an oxygen/carbon dioxide monitor, and a baffle being constructed so as to be releasably seated over the oxygen delivery aperture on the inner surface of the central portion of the mask, the baffle having a concave shaped wall and being configured and positioned so as to assist, during use of the mask, in creating turbulence in an oxygen flow leaving the oxygen delivery aperture and assist in mixing oxygen with ambient air and thereby avoid a direct flow of oxygen towards a patient's face, a carbon dioxide intake positioned within the concave shaped wall of the baffle, the carbon dioxide intake communicating with the carbon dioxide monitor tube.

5. A mask according to claim 12 wherein the bridge portions of the mask from a top of the mask to a bottom of the mask are configured in an inverted ‘Y’ shape so that openings are provided towards the bottom and sides of the mask for unobstructed access to and viewing of a patient's mouth and other parts of the patient's face.

6. A mask according to claim 12 wherein the wall and base are of cup-shaped appearance, the walls ending in an edge of triangular peripheral contour so as to conform, when the mask is in position on a patient, to the shape of a patient's nose and mouth area.

7. A mask according to claim 3 wherein the baffle comprises a post to be releasably seated centrally within the oxygen delivery apparatus at an end of the post and having a curled back conical lip, at another end of the post, an underside of the lip being in line with a flow of oxygen when passing from the oxygen delivery aperture during use of the mask so as to generate turbulence in the oxygen flow and create, in conjunction with the diffuser, a plume of oxygen enriched air at the patient's nose and mouth.

8. A mask according to claim 4 wherein the baffle comprises a post at one end to be seated centrally within the oxygen outlet, the post having centrally through it a passageway for oxygen/carbon dioxide monitoring centrally through it, the passageway communicating with the oxygen/carbon dioxide intake of the baffle and the oxygen/carbon dioxide monitor tube.

9. A mask according to claim 2 in combination with an adjustable strap means associated with the means to secure the strap means on the peripheral portion of the mask.

10. A mask according to claim 3 wherein the wall and base are of cup-shaped appearance, the walls ending in an edge of triangular peripheral contour so as to conform, when the mask is in position on a patient, to the shape of a patient's nose and mouth area.

11. A mask according to claim 4 wherein the wall and base are of cup-shaped appearance, the walls ending in an edge of triangular peripheral contour so as to conform, when the mask is in position on a patient, to the shape of a patient's nose and mouth area.

12. An oxygen delivery mask for wearing over the nose and mouth region of a patient, comprising:
a mask body for at least partially covering the patient's nose and mouth region, said mask body including a rim for contacting the patient's face surrounding the patient's nose and mouth;
a gas diffuser mounted to the body, said body having sufficient rigidity and shaped to space said diffuser apart from the patient's face, said diffuser for generating a turbulent plume of gas towards the patient's nose and mouth region and comprising a concave structure opening towards the patient's face formed by a base and a wall; and
a fastener to maintain contact between the patient's face and said rim;
wherein said mask body has openings therein with suitable size, shape, and location to permit the patient to perform functions of eating or drinking and to permit others to deliver substances to the patient's mouth, without removing said mask.
